(19) United States
(12) Patent Application Publication
(10) Pub. No.: US 2025/0389672 A1
(43) Pub. Date: Dec. 25, 2025

(54) LIGHT DIRECTED SINGULATION QUALITY CONTROL

(71) Applicant: Retiina, LLC, Owings Mills, MD (US)

(72) Inventors: Tyler Raney, Hillsboro, VA (US); Tom Hillerich, Louisville, KY (US); Gabe Difurio, Owings Mills, MD (US); Brent Raney, Hillsboro, VA (US); Justin Bodycomb, Baltimore, MD (US)

(73) Assignee: Retiina, LLC, Owings Mills, MD (US)

(21) Appl. No.: 19/244,406

(22) Filed: Jun. 20, 2025

Related U.S. Application Data
(60) Provisional application No. 63/662,807, filed on Jun. 21, 2024.

(51) Int. Cl. G01N 21/90; G01N 1/28; G01N 21/88; G01N 35/04

(52) U.S. Cl. CPC G01N 21/90; G01N 1/286; G01N 21/8851; G01N 35/04; G01N 2201/0407; G01N 2201/0438

(57) ABSTRACT

The present disclosure provides techniques for singulating parcels. In certain aspects, a method for singulating parcels includes obtaining one or more images of a first portion of a conveyor conveying one or more parcels, detecting at least one parcel being conveyed along the conveyor based on the one or more images, determining a defect associated with the at least one parcel, generating a corrective action for addressing the defect associated with the at least one parcel, and causing a visual indication device to provide a visual indication of the corrective action for addressing the defect.

### CROSS-REFERENCE TO RELATED APPLICATIONS

This application claims the benefit of prior filed U.S. Provisional Patent Application No. 63/662,807 filed on Jun. 21, 2024, which is incorporated herein by reference in its entirety.

### TECHNICAL FIELD

The present disclosure relates to techniques for singulating parcels.

### BACKGROUND

Singulation systems receive disorderly-arranged parcels and separate and line up the parcels into lines. Singulation systems may employ chutes, conveyors, rotating cones, and other mechanical devices. Singulation systems are designed to create a substantially single file line of parcels that are spread apart. However, singulation systems feed parcels onto a conveyor in non-specific orientations.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an illustrative diagram of a parcel processing center.

FIG. 2 schematically depicts an illustrative diagram of a singulation quality control system in the parcel processing center.

FIGS. 3A-3B depict illustrative examples of parcel defects and tasks.

FIGS. 4A-4B depict an illustrative rotate and gap process for a singulation quality control system.

FIGS. 5A-5B depict an illustrative instance of a singulation quality control system utilizing distinct indicators for each defect or task.

FIG. 6 depicts an illustrative process for incorporating a backfill conveyor in the singulation quality control system.

FIG. 7 depicts an illustrative schematic of a singulation quality control system having a low-pressure accumulation conveyor.

FIG. 8 depicts an illustrative schematic of a singulation quality control system having a light bar indicator.

FIG. 9 depicts an illustrative schematic of a singulation quality control system having an aligner.

FIGS. 10A-10C depict an illustrative large parcel handling process within the singulation quality control system.

FIG. 11 depicts illustrative implementations of an intermediate conveyor section configured to handle large parcel manipulation within the singulation quality control system.

FIG. 12 depicts an illustrative parcel manipulation operation.

FIG. 13 depicts aspects of an example method for singulation of parcels.

FIG. 14 depicts aspects of an example apparatus.

### DETAILED DESCRIPTION

Aspects of the present disclosure relate to techniques for singulating parcels. More specifically, the techniques described herein are directed to singulation quality control techniques. For example, singulation systems may be implemented at parcel processing centers. Parcel processing centers receive a plurality of parcels that need to be sorted and directed to a vehicle for further transport and/or delivery to a customer. Each of the parcels in the plurality of parcels may be a box or envelope that contains a Scan, Label, Apply, Manifest (SLAM) label. The SLAM label includes information such as the parcel identity, weight and dimensions, a manifest for a preferred carrier, handling and sorting information, and optionally more information. The SLAM label includes a scannable barcode which may be utilized in a SLAM line to direct the parcel within a parcel processing center. The SLAM label may be read at the parcel processing center, for example, by a camera system. When read by the camera system, the SLAM label may indicate additional labeling (e.g., a self-adhesive label) that is needed for the final handling of the parcel. The additional labels may include color and/or coded labels that assist a delivery vehicle and driver efficiently collect and deliver parcels along their route.

Since parcels may arrive at a parcel processing center in a bulk and unorganized fashion, the parcel processing center includes a layout of chutes, conveyors, motor driven rollers (MDR) rotating cones, aligners, wheel sorters, and other mechanical devices to singulate and direct the parcels to delivery vehicles, for example. The process processing center may also utilize cameras, photo-electric (PE) sensors, robots, processing systems, artificial intelligence (AI) processors and methods, human workers, and optionally an array of other devices to rapidly singulate, sort, label, and output parcels for delivery.

Some parcel processing centers may operate 24 hours a day, while others may only operate for a fraction of a day. During operation, the parcel processing center may process tens or hundreds of thousands of parcels per line per operating shift. The number of parcels to be processed translates into a need for very fast line speeds. For example, some line speeds may output 3,000-8,000 parcels per hour. In addition to the need for high-speed lines there is also a need that the singulation process effectively unstack, gap, and orient parcels for further processing through the parcel processing center. While singulation systems continue to improve, there are still challenges with handling a variety of parcels having different shapes, sizes, weights, and packaging mediums (e.g., box, envelope, bag). That is, singulation systems can output parcels that are stacked on top of each other, placed side-by-side on a conveyor, folded, askew or distant from a desired travel position on the conveyor, spaced apart from adjacent parcels (e.g., gapped inefficiently), and oriented such that the SLAM label or other label is not in a consistent position (e.g., facing upward) so that it may be electronically read in the parcel processing center.

Accordingly, techniques for improving the output of the singulation system include integrating human workers, robots, and other mechanical devices at the output of the singulation system. For example, human workers may be tasked with evaluating the output parcels, identifying defects, determining a resolution to the defect, and addressing the defect. At slow speeds these tasks are not challenging for a human worker and their efficiency and accuracy may be high when properly trained. However, as line speeds increase, for example, but without limitation, to 1,000 parcels per hour, to 2,000 parcels per hour, to 3,000 parcels per hour, 4,000 parcels per hour, 5,000 parcels per hour, 6,000 parcels per hour, 7,000 parcels per hour, 8,000 parcels per hour, or more, the time a human worker has to evaluate the output parcels, identify defects, determine a resolution to the defect, and address the defect becomes very short, for example about 0.4-3 seconds. Furthermore, some tasks such as rotating a large parcel so that the SLAM label faces upward can be a laborious and time-consuming task, especially when repeated at high speeds. Such a task can take a user a few seconds just to carry out the manipulation needed. During this time, a gap in the line may form and parcels may back up, thus decreasing the output per hour. Furthermore, while some tasks are assisted or carried out by robotic mechanisms, human workers are susceptible to fatigue, repetitive action injury, and error.

Aspects of the present disclosure provide quality control techniques for singulating parcels. As described in more detail herein, light assisted singulation quality control (QC) systems, methods, and devices are provided. These will be generally referred to as singulation QC herein. Aspects of singulation QC provide supervision over the output of parcels from the singulator, light based indicators corresponding to parcels and tasks to perform on the parcels, and the automatic assignment of tasks between the one or more human workers and optionally robotic devices operating along the singulation QC portion of the parcel processing system. Singulation QC may use cameras, computer vision, and AI processing to evaluate parcels received from the singulator. Evaluation of the parcels results in identifying one or more defects associated with the parcels. Defects may include cuts, dents, scraps, discoloration, or other damage to a parcel. Following identification of the one or more defects, the singulation QC system may implement a light-based indicator for highlighting to a worker an area and/or specific parcel that requires attention. In certain aspects as discussed in more detail herein, the light-based indicator may correspond to a particular action that needs to be performed on the parcel. For example, different colors may be used to indicate different tasks. Colors are only one example implementation of the light-based indicator. The light-based indicator may be generated by a projector that is configured to continue to illuminate the parcel as it moves through the singulation QC zone. Once a required task is performed on the parcel and evaluation by a second camera confirms completion of the task, and optionally, that no additional tasks are needed, the light-based indicator may stop providing indication that an action on the parcel is needed. Various aspects and implementations of the singulation QC system will now be described with reference to the figures.

The following will now describe these systems and methods in more detail with reference to the drawings and where like numbers refer to like structures.

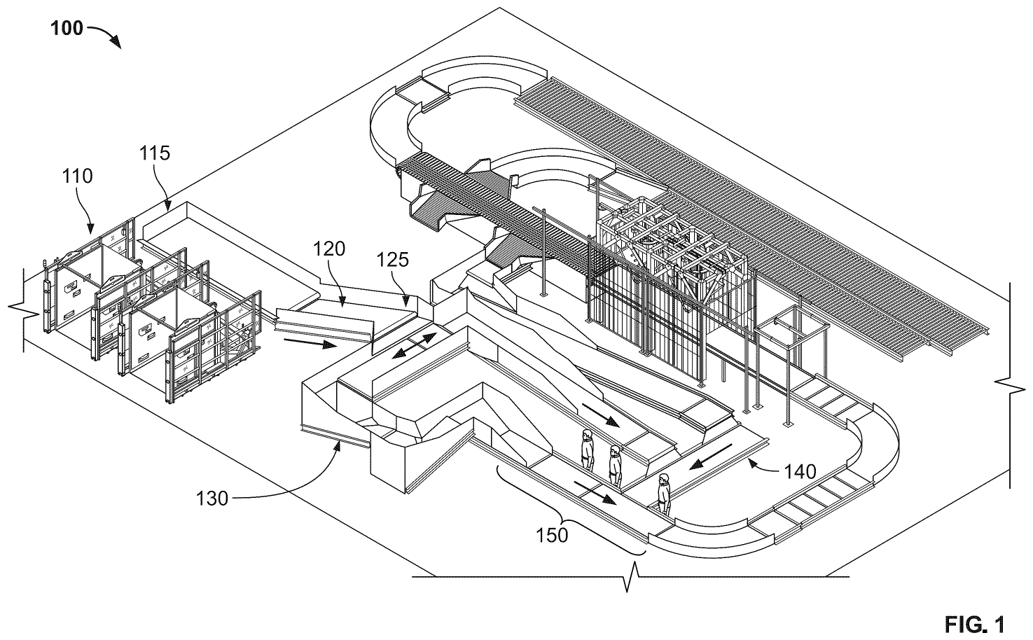

FIG. 1 schematically depicts an illustrative diagram of a parcel processing center 100. Parcel processing centers may include a variety of chutes, conveyors, motor driven rollers (MDR) rotating cones, aligners, wheel sorters, and other mechanical devices to singulate and direct the parcels to delivery vehicles. For purposes of the present disclosure the front end of a parcel processing center is the focus. A plurality of parcels is delivered to the parcel processing line, for example, via bins or trucks. Go-cart dumpers 110 transport the plurality of parcels from the bins or trucks to the parcel processing line 115. The parcel processing line 115 may proceed with an unstacker 120. The unstacker 120 may be an inclined conveyor that utilizes gravity and the upward motion of the conveyor to unstack parcels. At the top of the unstacker 120 there may be a diverter 125. The diverter 125 may be configured to direct a portion of the parcels in a first direction and a second portion of the parcels in a second direction. This may be an arbitrary diversion or there may be controls implemented to direct parcels of certain sizes and/or weights in the second direction. The parcels fed in the first direction may enter a singulator 130, while the parcels fed in the second direction may enter a backfill conveyor 140. In some aspects, the parcels fed in the second direction may proceed through a singulator as they enter the backfill conveyor 140.

The singulator 130 may employ chutes, conveyors, rotating cones, and other mechanical devices to create a substantially single file line of parcels that are spread apart. The singulator 130 outputs parcels to a conveyor which provides the parcels to the singulation QC 150. As will be described in more detail herein, the singulation QC 150 is configured to address defects in parcel orientation, location, spacing, and the like which was introduced by the singulator 130 or that the singulator 130 was unable to perfect.

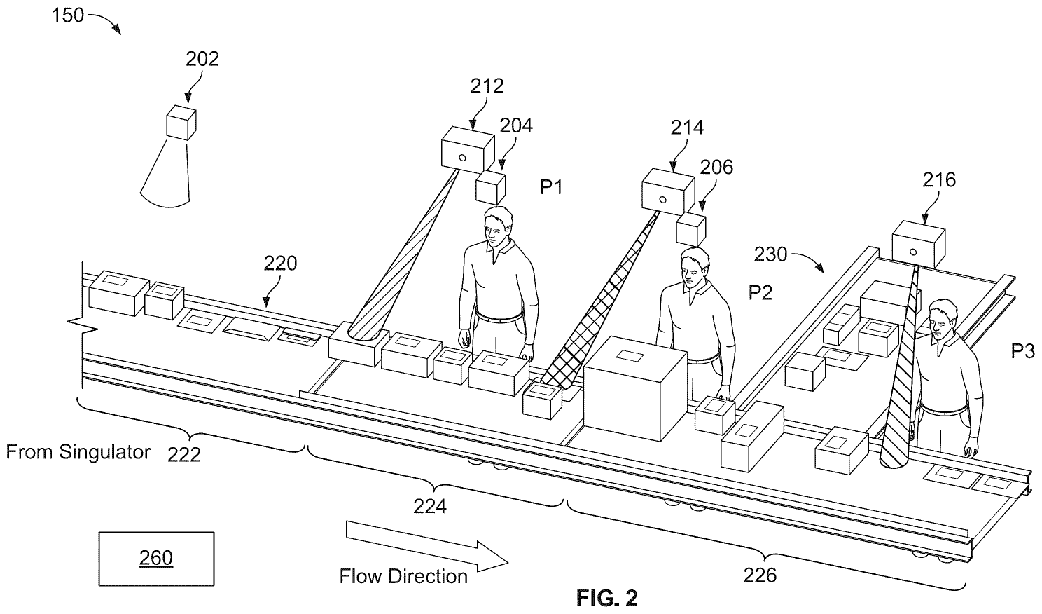

FIG. 2 schematically depicts an illustrative diagram of a singulation QC 150. Various aspects and implementations of the singulation QC 150 are provided herein. It is understood that aspects of some implementations of the singulation QC 150 may be interchanged with or incorporated into other aspects of the singulation QC 150.

The singulation QC 150 includes one or more cameras 202, 204, 206, one or more projectors 212, 214, 216, one or more conveyors 222, 224, 226, and one or more backfill conveyors 230, The one or more cameras 202, 204, 206, one or more projectors 212, 214, 216, one or more conveyors 222, 224, 226, and one or more backfill conveyors 230 may be communicatively coupled to a control unit 260. The singulation QC 150 may include other components such as electromechanical devices for control, one or more PE sensors or other types of sensors, and the like.

The one or more cameras 202, 204, 206 may be communicatively coupled to the communication bus and to the control unit 260. The one or more cameras 202, 204, 206 may be an IDS Imaging device such as the GV-527xCP-C model camera. The one or more cameras 202, 204, 206 may be any device having an array of sensing devices (e.g., pixels) capable of detecting RGB light, radiation in an ultraviolet wavelength band, a visible light wavelength band, or an infrared wavelength band. The one or more cameras 202, 204, 206 may have any resolution. The one or more cameras 202, 204, 206 may be an omni-directional camera, or a panoramic camera, for example. In some embodiments, one or more optical components, such as a mirror, fish-eye lens, or any other type of lens may be optically coupled to each of the one or more cameras 202, 204, 206. In embodiments described herein, the one or more cameras 202, 204, 206 may capture image data or video data of an environment of the parcel processing center, and more specifically of the parcels traversing the singulation QC 150.

The one or more projectors 212, 214, 216 may be communicatively coupled to the communication bus and to the control unit 260. The one or more projectors 212, 214, 216 may be an Epson device such as the EF-11 model projector. The one or more projectors 212, 214, 216 may be any light or image projecting device configured to project colored light, icons, images, or the like onto a surface. The one or more projectors 212, 214, 216 may include an articulating lens or be mounted to an articulation unit so that the projected light can be moved, directed, and focused on a variety of desired surfaces or objects. In some aspects, the one or more projectors 212, 214, 216 may be interchanged with other light indicating devices such as one or more light bars as described in more detail herein.

The one or more conveyors 222, 224, 226 may be communicatively coupled to the communication bus and to the control unit 260. The one or more conveyors 222, 224, 226 may comprise mechanically driven rollers, belts, wheels, or the like. The one or more conveyors 222, 224, 226 may include controllable motors such that the speed and direction of the one or more conveyors 222, 224, 226 may be controlled by one or more signals from the control unit 260 or another electromechanical device coupled thereto.

The communication bus may be formed from any medium that is capable of transmitting a signal such as, for example, conductive wires, conductive traces, optical waveguides, or the like. The communication bus may also refer to the expanse in which electromagnetic radiation and their corresponding electromagnetic waves traverse. Moreover, the communication bus may be formed from a combination of mediums capable of transmitting signals. In one embodiment, the communication bus comprises a combination of conductive traces, conductive wires, connectors, and buses that cooperate to permit the transmission of electrical data signals to components such as processors, memories, sensors, input devices, output devices, and communication devices. Accordingly, the communication bus may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication bus communicatively couples the various components of the singulation QC 150. As used herein, the term “communicatively coupled” means that coupled components are capable of exchanging signals with one another such as, for example, electrical signals via conductive medium, electromagnetic signals via air, optical signals via optical waveguides, and the like.

The control unit 260 may be any device or combination of components comprising one or more processors and the memory component comprising one or more memories. The processor may be any device capable of executing the machine-readable instruction set stored in the memory component. The processor may be an AI processor. Accordingly, the processor may be an electric controller, an integrated circuit, a microchip, a field programmable gate array, a computer, or any other computing device. The processor is communicatively coupled to the other components of the singulation QC 150 by the communication bus. Accordingly, the communication bus may communicatively couple any number of processors with one another, and allow the components (e.g., the one or more cameras 202, 204, 206 and/or the one or more projectors 212, 214, 216) coupled to the communication bus to operate in a distributed computing environment. Specifically, each of the components may operate as a node that may send and/or receive data.

The memory component of the control unit 260 is coupled to the communication bus 220 and communicatively coupled to the processor. The memory component may be a non-transitory computer readable memory and may comprise RAM, ROM, flash memories, hard drives, or any non-transitory memory device capable of storing machine-readable instructions such that the machine-readable instructions can be accessed and executed by the processor. The machine-readable instruction set may comprise logic or algorithm(s) written in any programming language of any generation (e.g., 1GL, 2GL, 3GL, 4GL, or 5GL) such as machine language that may be directly executed by the processor 232, or assembly language, object-oriented programming (OOP), scripting languages, microcode, etc., that may be compiled or assembled into machine readable instructions and stored in the memory component. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The singulation QC 150 may receive parcels from the singulator 130. As the parcels enter the singulation QC 150, a first camera 202 captures images (or video) of the parcels. The first camera 202 may be positioned above or associated with a first conveyor 222, such that the first camera 202 has a viewpoint of parcels approaching and/or traversing the first conveyor 222. The first camera 202 may have a field of view that captures an area of the first portion of the first conveyor 222. In some aspects, one or more mirrors may be provided at an angle along the first conveyor 222 so that the first camera 202 may have a side view of the parcels moving along the first conveyor 222. In this way the image data captured by the first camera 202 may include additional information as to orientation of the parcel when the SLAM label is not visible from directly above. This additional information may be utilized to provide the worker with instructions, for example, which direction to flip or rotate a parcel so that the SLAM label is facing upward.

A control unit 260 may evaluate the image data, for example, with computer vision software and algorithms. The control unit 260 is configured to identify defects such as parcels that are stacked on top of each other, parcels placed side-by-side in a lateral direction a conveyor, folded, askew or distant from a desired travel position on the conveyor, spaced apart from adjacent parcels (e.g., gapped inefficiently), and oriented such that the SLAM label or other label is not in a consistent position (e.g., facing upward or other orientation) so that it may be electronically read in the parcel processing center. Lateral direction of the conveyor refers to the direction perpendicular to the direction of flow and longitudinal direction refers to the direction along the direction of flow of the conveyor. The control unit 260 may be configured to locate SLAM labels and parcel edges, while associating the SLAM labels with each parcel detected through, for example, an edge detection process or other computer vision technique. Such operations may be programed or configured within computer vision-based systems and/or AI models trained to recognize objects and classify the objects' orientations as acceptable or unacceptable.

In certain aspects, the one or more camera 202, 204, 206 may be mounted above the induction point of the conveyor system to analyze packages as they enter. Images are taken cyclically to ensure any parcel that enters has been captured. The image of parcels may be passed into the “package contouring” AI model. The “packaging contouring” AI model identifies the outer edges of each package, referred to as its contour. The same image may then pass into the “Label Detection” AI Model. The “Label Detection” AI model identifies the presence of package labels within the image and returns their contours. Using the location of the package contours and the label contours, a determination can be made whether a parcel has been oriented properly on the conveyor (e.g., a belt or roller).

If a parcel is oriented properly (e.g., where the SLAM label is facing a predefined orientation or direction) on the conveyor at the point of induction, the projector highlights the parcel with a distinct color (e.g., green) to indicate that it is ready to be processed down the conveyor. If a parcel is not oriented properly, a different distinct color (e.g., red) may be projected onto the package to indicate to operators that the package should be handled and corrected.

When the control unit 260 identifies a defect, the control unit 260 determines one or more action needed to correct the defect. The one or more actions may be predefined routines that are defined and associated to corresponding defects. For example, a parcel where the SLAM label is not visible by the first camera 202 or is not facing upward, the control unit 260 may determine that a rotation or flip (e.g., an action) of the parcel is needed. The control unit 260 may further determine which worker to assign the action to. The assignment of the action may be based on a worker's profile which may include performance metrics for handling certain types of defects, any restrictions to manipulating parcels of certain sizes and/or weights, the recent actions performed by the worker, and other metrics. For example, a worker aligned with an intermediate conveyor 224, which may optionally be speed adjusted so that more time-consuming actions can be performed, such as flipping and rotating parcels, may be the worker that is best suited for the action. Thus, the control unit 260 may make that determination and not indicate to a first worker that a parcel needs to be flipped and/or rotated. In some instances, the control unit 260 may be configured to track the type and volume of actions a particular worker has performed. If a worker along the conveyor line is overworked according to a volume and/or type-based threshold then certain actions for a period of time will be diverted from that worker. Whereas, if a worker has been idle for a period of time, then the control unit 260 may be configured to prioritize assignment of actions to that worker over other workers.

The control unit 260 indicates that a worker needs to take action on a parcel by signaling to the one or more projectors 212, 214, 216 to illuminate the parcel or area that the parcel is located. The one or more projectors 212, 214, 216 are configured to continue (e.g., track) illuminating the parcel as it moves along the one or more conveyors 222, 224, 226. In some aspects, each work may be assigned a particular-colored illumination to attend to. For example, a worker in position 1 (e.g., a first workstation that may be associated with the first conveyor 222 or the second conveyor 224) may only take action on parcels illuminated with a blue light, a worker in position 2 (e.g., a second workstation that may be associated with the second conveyor 224 or the third conveyor 226) may only take action on parcels illuminated with a red light, and a worker in position 3 (e.g., a third workstation that may be associated with the third conveyor 226) may only take action on parcels that are illuminated with a green light. In some aspects, the one or more projectors 212, 214, 216 may only illuminate the parcel that needs to be acted upon when it is within a predefined distance (e.g., when it is within arm's reach) of the worker. In this way, the worker at each position is only viewing illuminations from the projector that they need to act upon. In some aspects, the color of the illumination may correspond to a particular action that needs to be performed. For example, blue light may indicate that a parcel needs to be flipped or rotated, a red light may indicate that there are parcels positioned side-by-side in a lateral direction that need to be lined up in single file, and a green light may indicate that there is a gap in the line where a new parcel may be added, for example from the backfill conveyor 230.

In some aspects, the singulation QC 150 may utilize icons in the indications that are projected by the one or more projectors 212, 214, 216. For example, directional rotate icons (e.g., arrows) or flip icons (e.g., curved arrows) may be displayed to the worker which provides the worker with the specific action that needs to be taken on the parcel. A division symbol “=” may be used to indicate parcels positioned side-by-side in a lateral direction that need to be lined up in single file. Lateral or longitudinal lines projected on a parcel may indicate that a parcel needs to be realigned to those projected lines because it is askew with respect to the conveyor. Other icons may include an empty box indicating to the worker to fill the gap outlined by the box with a parcel. These are just a few examples of the many different types of icons that may be implemented to inform the worker as to the action that should be taken.

Aspects of the singulation QC 150 include one or more additional cameras, such as a second camera 204 and/or a third camera 206. The second camera 204 and/or the third camera 206, like the first camera 202, are configured to capture images (or video) of the parcels as they pass through their respective fields of view along the one or more conveyors 222, 224, 226 of the singulation QC 150. The control unit 260 receives the image data from the second camera 204 and/or the third camera 206 and may carry out similar operations as performed on image data from the first camera 202. That is, the parcels are further evaluated for defects as defects may have been introduced by the workers manipulating the parcels, missed by evaluation of the image data from the first camera 202 (e.g., because the defect was obstructed from view), or the defect of the parcel has not yet been remedied. Accordingly, the control unit 260 performs defect detection on the image data from the second camera 204 and/or the third camera 206. When defects are detected, an action is determined and assigned to a worker. The control unit 260 signals to the one or more projectors 212, 214, 216 to provide the worker with the indication through illumination as to which parcel action is needed.

In addition to performing defect detection, the control unit 260 may further carry out a resolution confirmation process on the image data from the second camera 204 and/or the third camera 206. The resolution confirmation process receives an indication of a defect detected by evaluation of image data captured by one or more of the upstream cameras. The control unit 260 identifies the parcel corresponding to the previously identified defect and determines whether the defect has been resolved based on the new (downstream) image data of the parcel. When the control unit 260 determines that the defect has been resolved, the control unit 260 may signal the one or more projectors 212, 214, 216 tracking and indicating the parcel, to stop indicating that action on the parcel is needed. That is, the one or more projectors 212, 214, 216 stop illuminating the parcel or area of the conveyor corresponding to the parcel based on indication from the control unit 260.

In certain instances, the control unit 260 may determine that there is a gap between parcels where one or more additional parcels may be placed into the line. This may occur when there is a delay upstream, for example from the singulator 130 or when a delay is intentionally introduced to handle the reorientation of a parcel. When there is a gap, a worker may be directed through the illumination of a gap by the one or more projectors 212, 214, 216 to add a parcel. The additional parcel may be retrieved from the backfill conveyor 230. In some aspects, a camera may be positioned to view the parcels on backfill conveyor 230 and a projector may be positioned to indicate through light from the projector which one of the parcels on backfill conveyor 230 is a good candidate for inserting in the gap on the line (e.g., on the third conveyor 226).

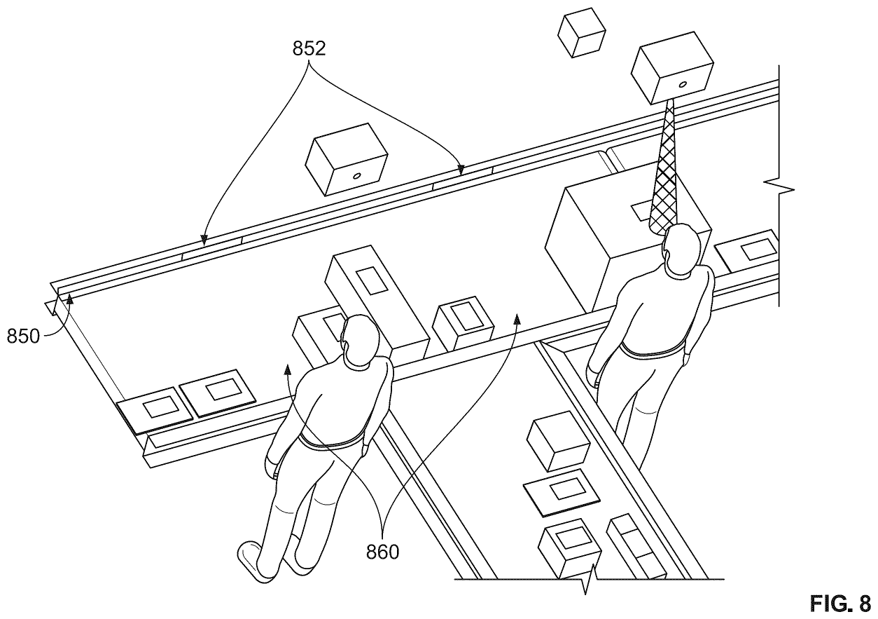

It is understood that while aspects of the singulation QC 150 are described with reference to a single control unit 260, more than one control unit 260 may be implemented. Additionally, the use of the one or more projectors 212, 214, 216 configured to provide light based indications is only one example. Some aspects may utilize light bars along the one or more conveyors 222, 224, 226, for example as depicted and described with reference to FIG. 8. The one or more projectors 212, 214, 216, the light bars, and other similar devices may collectively be referred to as visual indication devices. Additional aspects and variations of the singulation QC 150 will now be discussed.

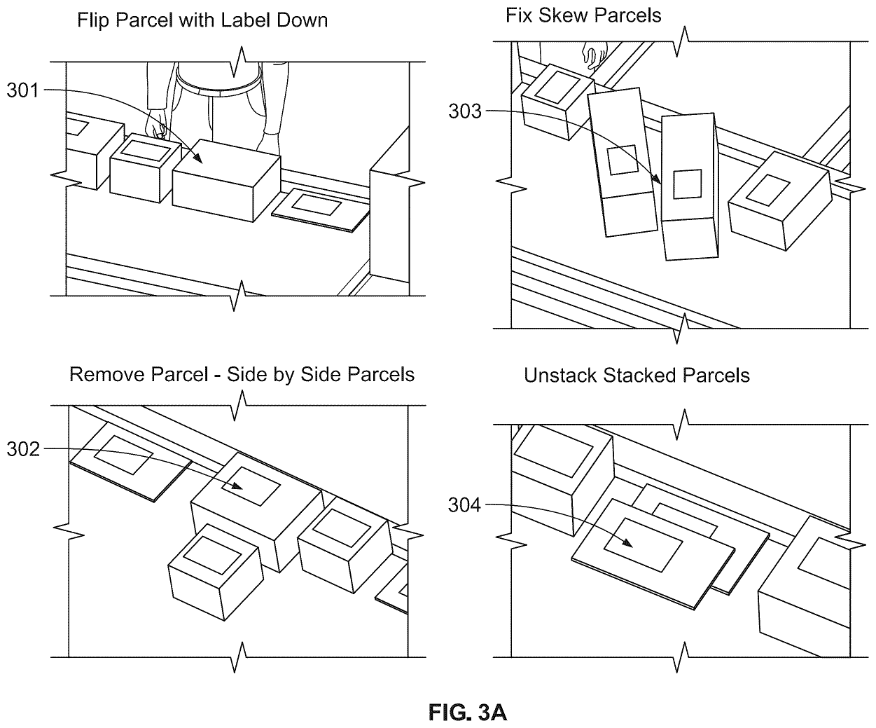

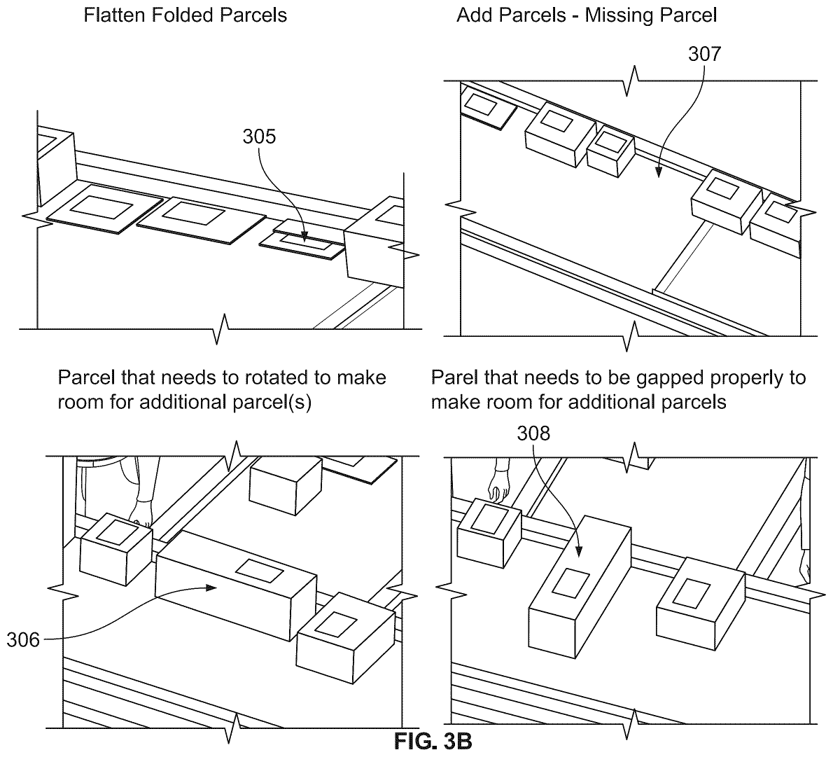

FIGS. 3A-3B depict illustrative examples of parcel defects and tasks. In FIG. 3A, image 301 depicts a parcel in an orientation where the SLAM label is not facing upwards. This may be considered a defect and an associated action for resolving the defect may include flipping or rotating the parcel. Image 302 depicts two parcels positioned side-by-side in a lateral direction. A goal of singulation is to align all of the parcels in a single file line. When the singulator is unable to achieve this goal for every parcel, the singulation QC 150 may identify instances of two parcels positioned side-by-side as a defect. Resolving an instance of two or more parcels positioned side-by-side may include repositioning the parcels into a single file line and/or removing one or more of the parcels, which may be added back in later from the backfill conveyor 230. Image 303 depicts two parcels that are askew. Parcels that are askew (e.g., overlap in a lateral or longitudinal direction with another parcel or are not squarely aligned with the conveyor) take up more space on the conveyor than necessary and may not facilitate efficient and accurate downstream processing such as application of an additional label. The parcels that are askew are indicated as a defect and an action of realigning the parcels may be indicated with the one or more projectors 212, 214, 216 and performed to correct the defect by a robot or a human worker. Image 304 depicts two parcels that are stacked on top of each other. Similar to the side-by-side defect, each parcel needs to be positioned within its own space on the conveyor. If no space is available for one or more of the stacked parcels, they may be removed to the backfill conveyor 230 and fed back into the line when a gap occurs.

Referring to FIG. 3B, image 305 depicts an envelope or bag type parcel that is folded such that a portion of the SLAM label is not visible. An unfolding action may be defined and indicated in response to identification of this defect. Image 306 depicts a parcel that may be rotated to accommodate additional space on the conveyor. A rotation action may be defined and indicated in response to the identification of this defect. Image 307 depicts an instance where there is a gap in the line. This may be determined to be a defect and indication to add one or more additional parcels to the gap may be provided to the worker. Image 308, similar to image 306, depicts a parcel that may be rotated to accommodate additional space on the conveyor. Here, a longitudinal move action may be defined and indicated in response to identification of this defect.

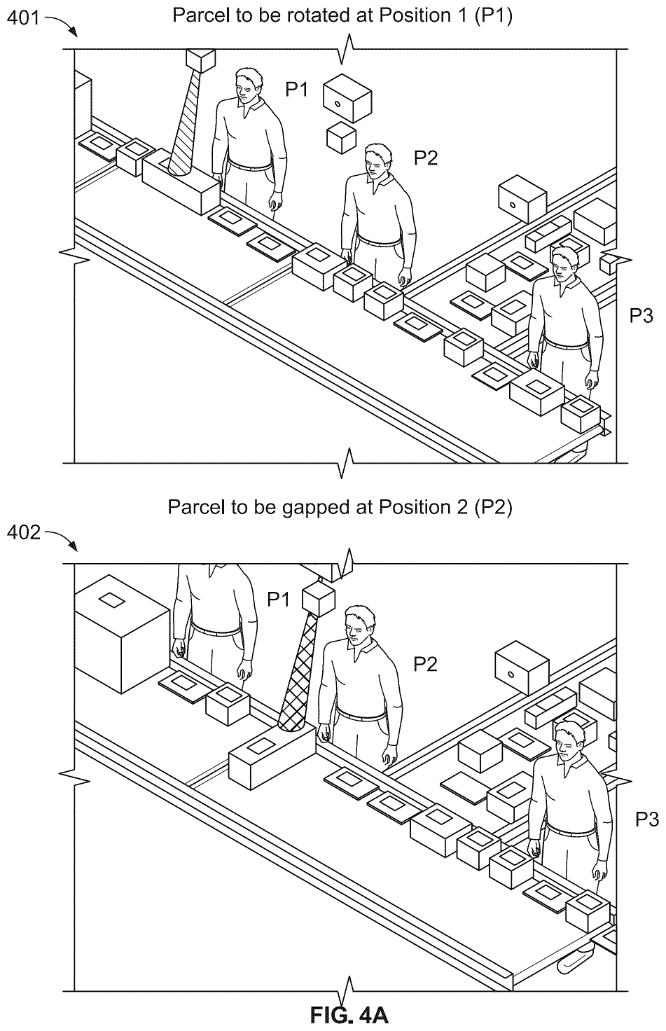

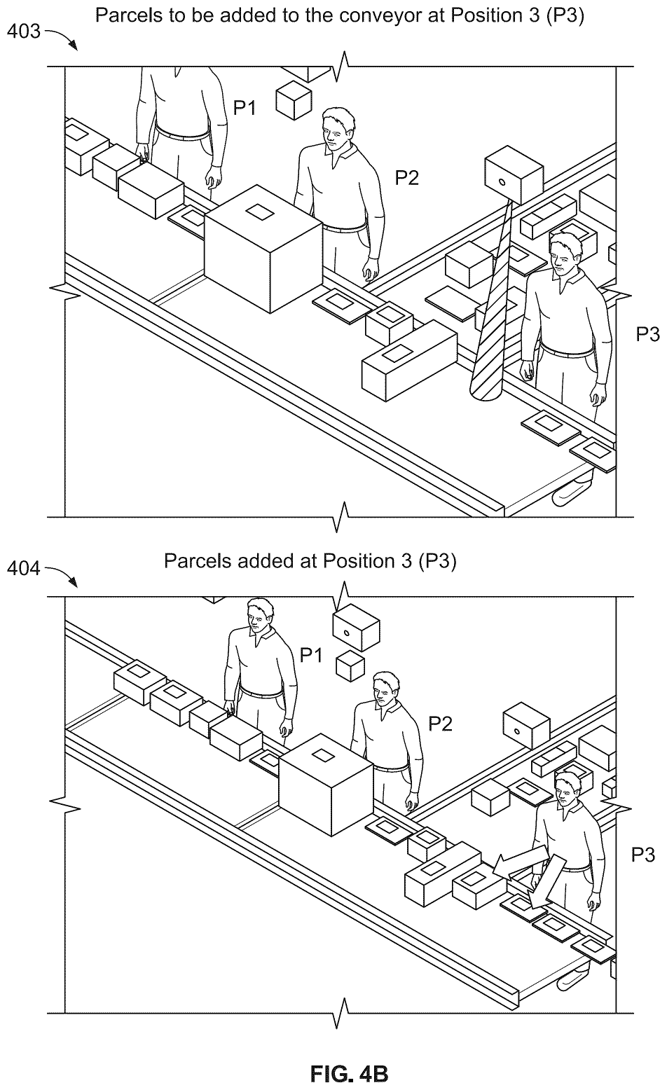

FIGS. 4A-4B depict an illustrative rotate and gap process for a singulation quality control system. While the following is described with reference to separate workers performing actions to resolve the defect, it is understood that one worker may be tasked with a sequential set of actions to resolve one or more defects. Furthermore, in some instances a resolution to one defect may introduce a new defect corresponding to the same parcel. It is advantageous to reduce the occurrence of the introduction of new defects, but the following illustrates that the singulation QC 150 may respond to new defects as a parcel proceeds through the singulation QC 150.

As depicted in image 401, the control unit 260 may identify, for example, from image data obtained from the first camera 202, a parcel to be rotated to make room on the conveyor. The first projector 212 may indicate through light (e.g., blue light) which parcel needs to be rotated based on signals from the control unit 260. The worker in the first position rotates the parcel and the parcel proceeds along the conveyor.

Image 402 depicts the parcel moving from the worker in the first position toward the worker in the second position. A second camera 204 captures image data of the rotated parcel and the control unit 260 determines that the parcel may be moved in a longitudinal direction to accommodate the addition of another parcel on the conveyor. The second projector 214 may indicate through light (e.g., red light) which parcel needs to be move in a longitudinal direction based on signals from the control unit 260. The worker in the second position may move the parcel according to the indication and the parcel proceeds along the conveyor. We note that the rotation and longitudinal movement of the parcel may be tended to by only the worker in the first or the second position. For example, during training of workers, there may be instructions to reduce the number of large gaps when performing some types of actions. In some aspects, a wheel sorter may be implemented along the conveyor line and operations such as parcel rotation, lateral movements, and/or longitudinal movements may be automatically performed based on signals from the control unit 260 in response to identification of the corresponding defects.

Images 403 and 404, depicted in FIG. 4B, depict indication of the gap with light (e.g., a green light or other color of light and/or icon projected on the conveyor within the gap) from the third projector 216 and insertion of two additional parcels onto the conveyor by the worker in position 3.

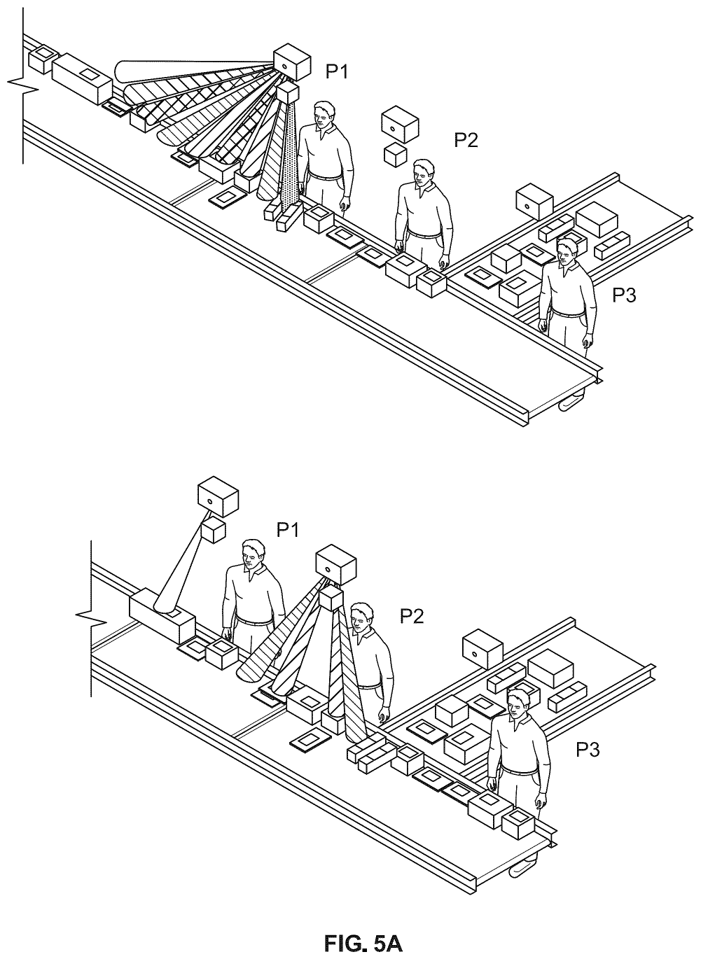

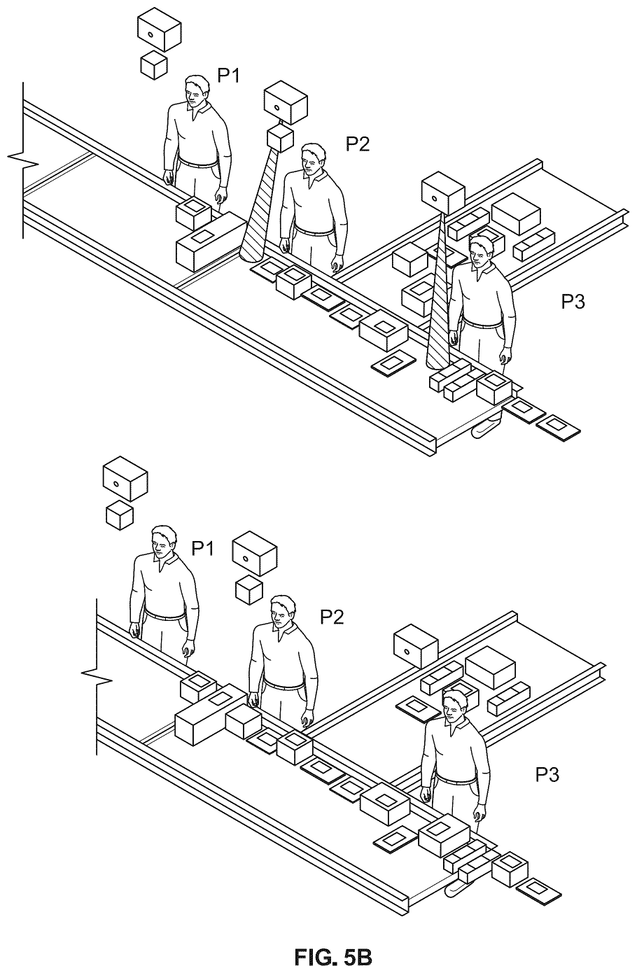

FIGS. 5A-5B depict an illustrative instance of a singulation quality control system utilizing distinct indicators for each defect or task. As discussed above, in some aspects the light-based indications may include a plurality of colored light where each color corresponds to a different defect. Progressing through the example illustrated in the images of FIGS. 5A-5B, it can be observed that the worker at the first position is presented with nine different defects. The worker in the first position may attempt to address as many as possible as the parcels pass through the first position. The remaining unresolved defects may remain illuminated as they proceed to the worker in the second position who may also attempt to address as many as possible as the parcels pass through the second position. When the parcels reach the worker in the third position, the remaining action may only be to add parcels from the backfill conveyor 230.

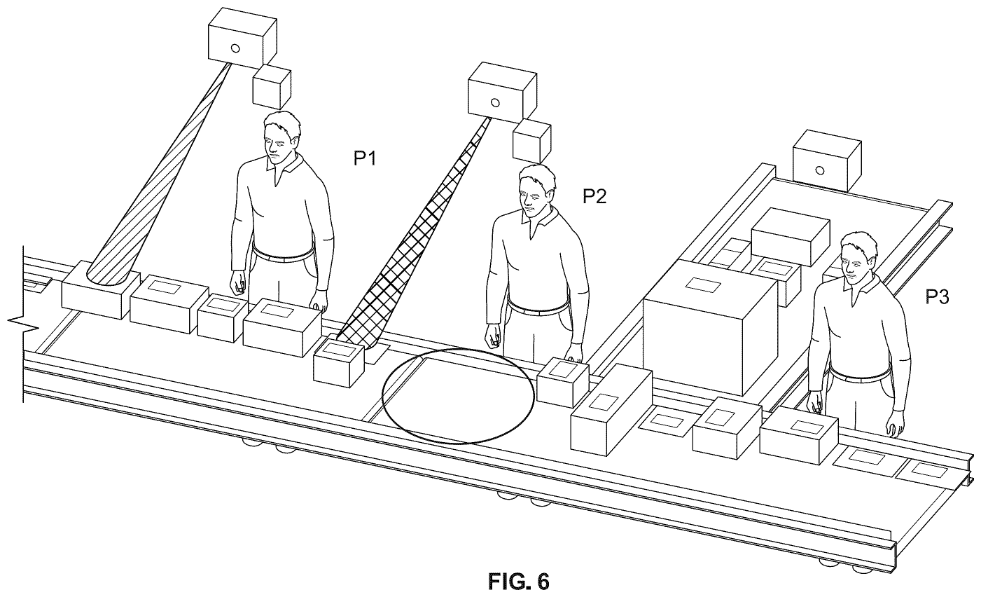

FIG. 6 depicts an illustrative process for incorporating a backfill conveyor 230 in the singulation quality control system. Operations associated with the backfill conveyor 230 may be associated with the workers that are adjacent the backfill conveyor 230. In some aspects, large parcels (e.g. parcels with large dimensions or weight) are diverted to the backfill conveyor 230 by the diverter 125. This may be done because large parcels may require additional time to handle (e.g., flip or rotate) than what may be available as the parcels move along the one or more conveyors 222, 224, 226. The backfill conveyor 230 provides a location for a worker, for example, the worker in the third position to address defects with the large parcels on the backfill conveyor 230 so they are ready to be added to the conveyor when there is a gap. The gap may be naturally occurring or manually triggered. For example, when a large parcel reaches the end of the backfill conveyor 230 it needs to be added to the line so that any other smaller parcels on the backfill conveyor 230 can be made available to fill other gaps as they occur. To facilitate the addition of a large parcel, the worker in the third position may activate a foot pedal that causes the second conveyor 224 to stop or slow down so that a gap forms or a gap increases in the line. The worker in the third position may then move the large parcel from the backfill conveyor 230 to the conveyor and release the foot pedal allowing the second conveyor 224 to resume normal operation. In some instances, the control unit 260 based on image data obtained from the one or more cameras 202, 204, 206 may automatically cause gaps to be formed by controlling the speed or operation of the one or more conveyors 222, 224, 226.

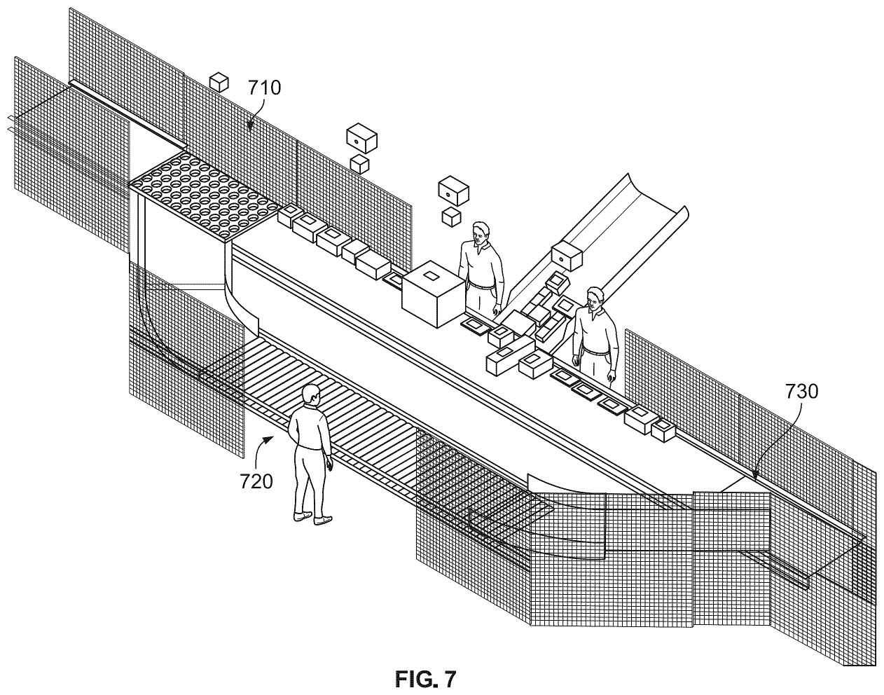

Handling of large parcels may be accommodated by other means. FIG. 7 depicts an illustrative schematic of a singulation quality control system having a low-pressure accumulation conveyor (e.g., a siding 720). In some aspects, the singulation QC 150 portion of the parcel processing center may include a siding 720, which is a low-speed, low pressure conveyor section. When a large parcel is identified, for example, by evaluation of image data from the first camera 202 or based on weight sensors or PE sensors, a wheel sorter 710 may cause large parcels to be routed to the siding 720. A worker stationed along the siding 720 may perform one or more actions on the large parcel and fed it back into the main conveyor line. When a large parcel is ready to return to the main conveyor line, the control unit 260 may cause a gap to form so the large parcel may feed back into the main conveyor line. Every large parcel does not need to proceed through the siding 720. The control unit 260 may only cause those large parcels that have a defect the needs to be addressed to be routed to the siding 720.

FIG. 8 depicts an illustrative schematic of a singulation quality control system having a light bar 850 indicator. In some aspects, the light-based indication may be facilitated by a light bar positioned along the conveyor and visible by the worker. The principal operations of using colors to assign actions, colors to indicate the type of action, and the display of icons to the worker as discussed with reference to implementation of the one or more projectors 212, 214, 216 can apply to the light bar 850. The light bar 850 may include a sequence of LEDs to provide light base indication 852 such as gaps 860 in the conveyor line. The light bar 850 may also be an LED array or digital display capable of displaying icons.

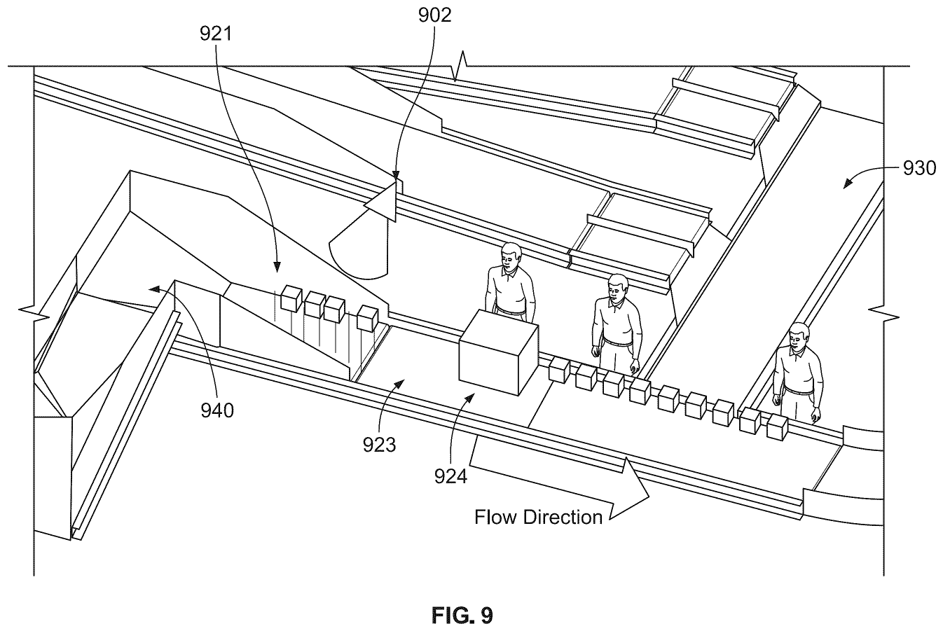

FIG. 9 depicts an illustrative schematic of a singulation quality control system having an aligner. In some aspects, the singulation QC 150 may include an aligner 921 positioned to receive the output of the singulator 940. The aligner 921 may cause the parcels on the conveyor to be laterally moved toward a side where the workers are stationed. The aligner 921 may be a mechanical device or an electromechanical device having actuators controlled based on image data of the from the first camera 902 to laterally move the parcels toward a side where the workers are stationed. Certain aspects also include an intermediate conveyor 924 that can be used to create space 923 for filing and/or rotating parcels. The space 923 created by the intermediate conveyor 924 can be filled with parcels from the backfill conveyor 930 as discussed herein.

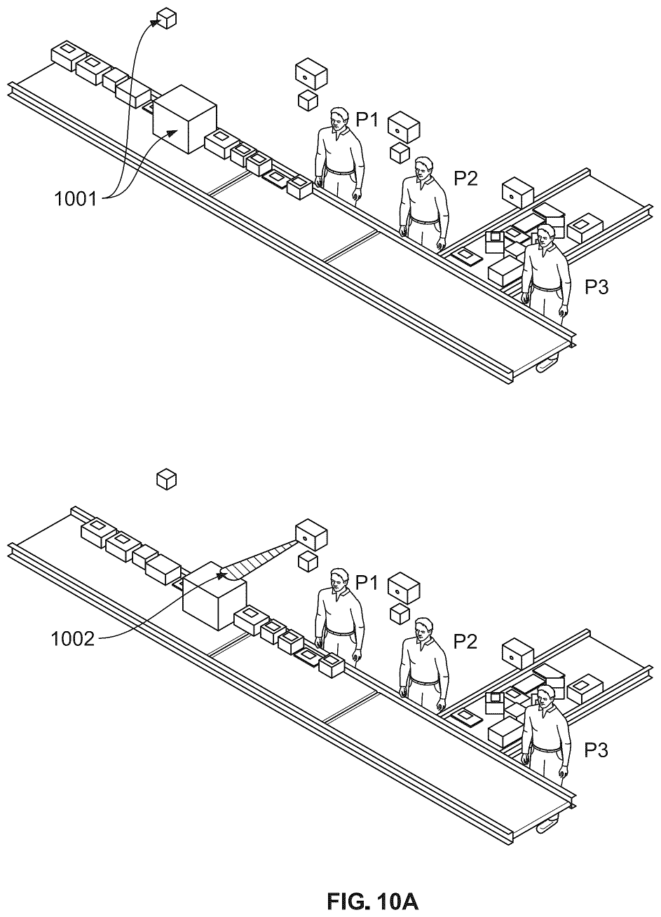

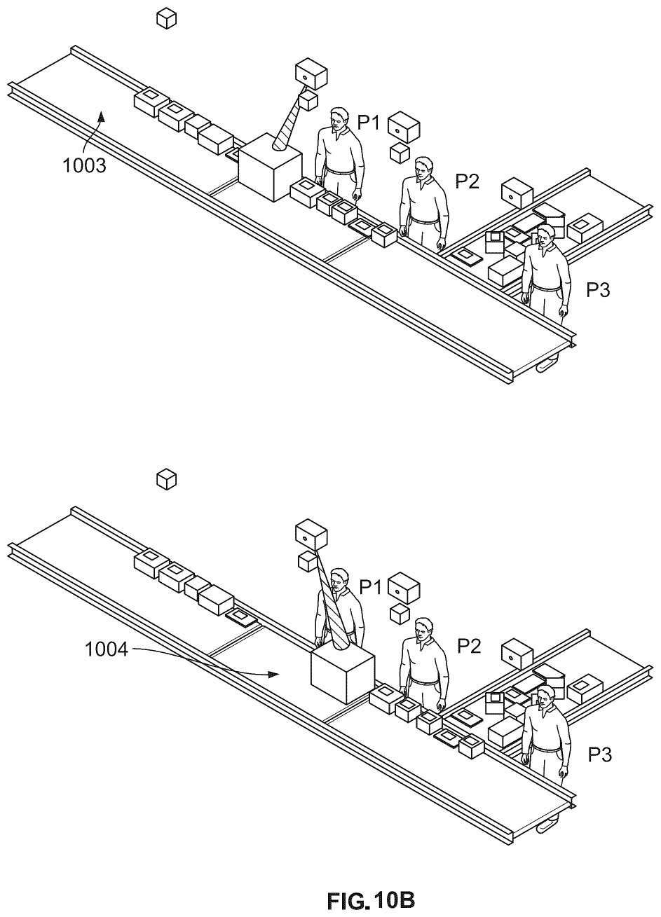

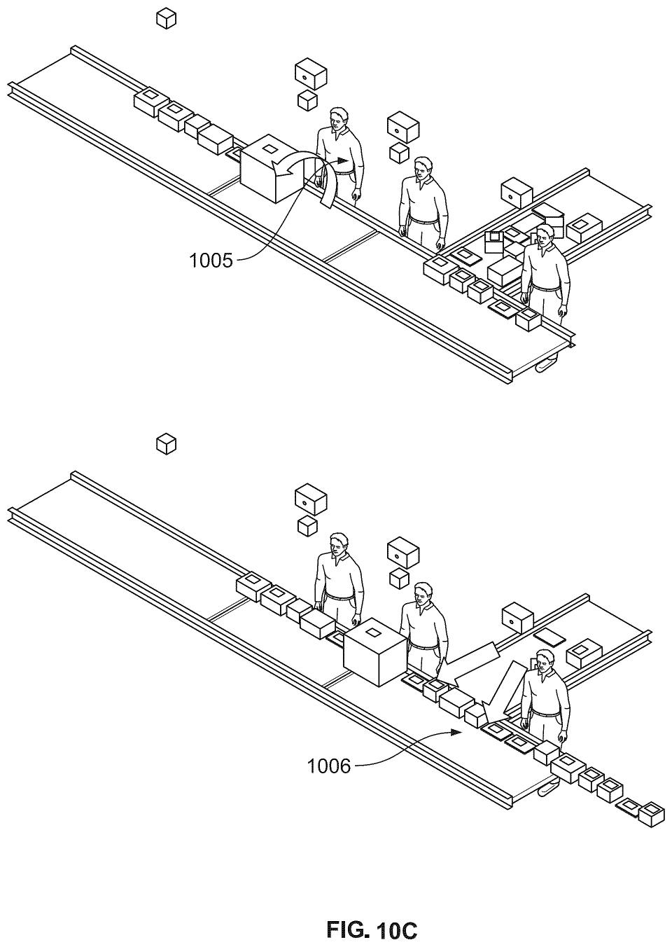

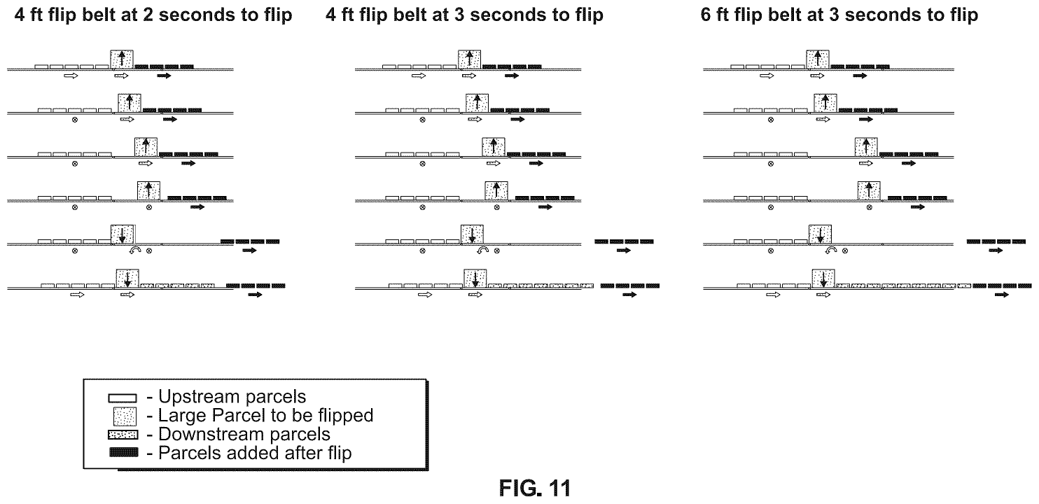

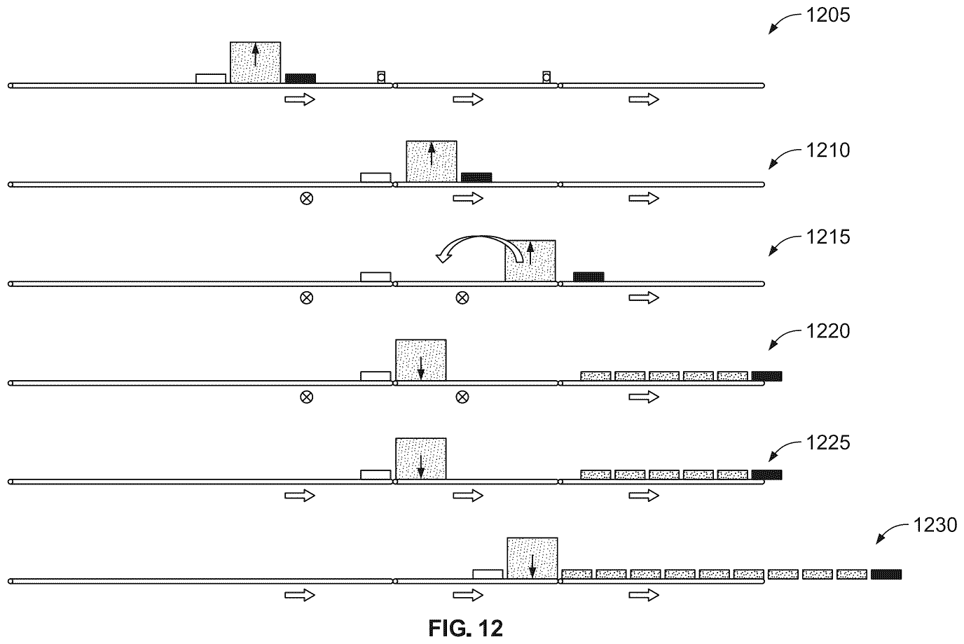

FIGS. 10A-10C depict an illustrative large parcel handling process within the singulation quality control system. Image 1001 depicts a large parcel where the SLAM label is facing down. A projector illuminates the parcel with light to indicate the parcel needs to be flipped as depicted in image 1002. The parcel advances from the feed conveyor to the intermediate conveyor. The feed conveyor stops, while the intermediate conveyor continues to move to create space for flipping actions to be performed on the large parcel as depicted in images 1003 and 1004. In image 1005, the worker performs a flipping operation so that the SLAM label faces upwards. The third conveyor may continue to move throughout the process and additional parcels may be added to the line by the second and/or third worker from the backfill conveyor as depicted in image 1006. Once the large parcel is reoriented so that the SLAM label faces upwards the intermediate conveyor resumes operation and advances the large parcel. FIGS. 11 and 12 depict some illustrative diagrams corresponding to the illustrative process depicted in FIGS. 10A-10C.

FIG. 11 depicts illustrative implementations of an intermediate conveyor section configured to handle large parcel manipulation within the singulation quality control system. The examples depicted in FIG. 11 provide illustrative designs and flipping timings that may be considered and implemented for the singulation QC 150. FIG. 12 depicts an illustrative parcel manipulation operation. At step 1205 all conveyors are running. At step 1210, the feed conveyor stops when the large parcel leaves the feed conveyor. This may occur automatically based on one or more signals from the first PE sensor indicating to the control unit that the large parcel has based the first PR sensor positioned at the transition of the feed conveyor and the intermediate conveyor. At step 1215, the intermediate conveyor stops when the large parcel reaches the second PE sensor positioned at the transition of the intermediate conveyor and the output conveyor. The large parcel may then be flipped and/or rotated to position the SLAM label to face upward. At step 1220, a time delay may be set and run so that the worker can flip and/or rotate to position the SLAM label to face upward. At step 1220, the delay may be determined based on evaluation of image data from one or more of the cameras viewing the large parcel. When the control unit determines from the image data that the SLAM label on the large parcel is facing upward, the control unit may cause the intermediate conveyor resume operation. At step 1225, the feed conveyor and the intermediate conveyor resume operation, which is further depicted in step 1230. During the stoppage of the intermediate conveyor, additional parcels can be added from the backfill conveyor onto the output conveyor since the output conveyor is not stopped.

Aspects of the present disclosure relate to techniques for singulating parcels. In particular, the present disclosure provides quality control techniques for singulating parcels. The light assisted singulation quality control (QC) systems, methods, and devices provide supervision over the output of parcels from the singulator, light-based indicators corresponding to parcels and tasks to perform on the parcels, and the automatic assignment of tasks between the one or more human workers and optionally robotic devices operating along the singulation QC portion of the parcel processing system. Singulation QC may use cameras, computer vision, and AI processing to evaluate parcels received from the singulator. Evaluation of the parcels results in identifying one or more defects associated with the parcels. Following identification of the one or more defects, the singulation QC system may implement a light-based indicator for highlighting to a worker an area and/or specific parcel that requires attention.

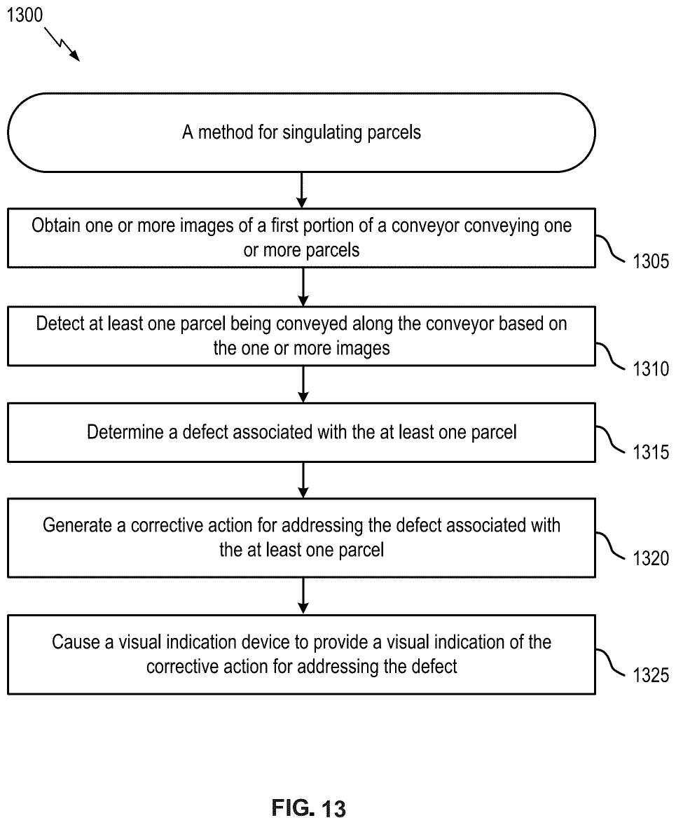

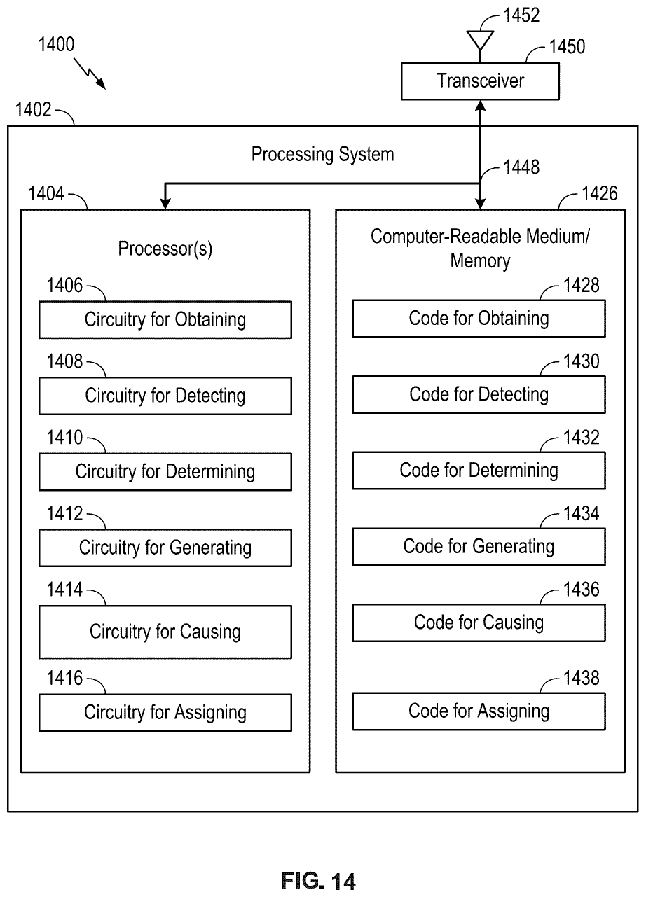

FIG. 13 shows an example method 1300 for singulation of parcels with an apparatus, such as the control unit 260 or the apparatus 1400 of FIG. 14. Aspects of the method 1300 can be implemented by the control unit 260 comprising one or more processors and a non-transitory computer readable memory and/or the apparatus 1400 of FIG. 14.

Method 1300 begins at block 1305 with obtaining one or more images of a first portion of a conveyor conveying one or more parcels. The one or more images may be obtained with the one or more cameras 202, 204, 206. The one or more cameras 212, 214, 216 may be configured to view the first portion of the conveyor and capture the one or more images of the first portion of the conveyor conveying the one or more parcels.

Method 1300 proceeds to block 1310 with detecting at least one parcel being conveyed along the conveyor based on the one or more images.

Method 1300 proceeds to block 1315 with determining a defect associated with the at least one parcel. In some aspects, determining the defect associated with the at least one parcel includes identifying a location of a SLAM label on the at least one parcel, and determining that the SLAM label is in an orientation other than a predefined orientation. In some aspects, the defect comprises at least one of: an undesired orientation of the at least one parcel; the at least one parcel includes a fold; two or more parcels including the at least one parcel are positioned side-by-side in a lateral direction with respect to the conveyor; or two or more parcels including the at least one parcel are overlap each other. In some aspects, the defect comprises a gap located before or after the at least one parcel and the processing system is configured to cause the visual indication device to provide the visual indication corresponding to an action to add a parcel in the gap by illuminating the gap with the visual indication.

Method 1300 proceeds to block 1320 with generating a corrective action for addressing the defect associated with the at least one parcel.

Method 1300 proceeds to block 1325 with causing a visual indication device to provide a visual indication of the corrective action for addressing the defect. The visual indication device may be one or more projectors 212, 214, 216. The one or more projectors 212, 214, 216 may be configured to project a light-based indication onto the at least one parcel or the first portion of the conveyor and the light-based indication is the visual indication of the corrective action. In some aspects, the visual indication device may be one or more light bars communicatively. The one or more light bars may be positioned along the first portion first of the conveyor. The one or more light bars may be configured to project a light-based indication is the visual indication of the corrective action. The visual indication comprises a respective color corresponding to the corrective action of a plurality of corrective actions. The visual indication comprises a respective icon corresponding to the corrective action of a plurality of corrective actions.

In some aspects, method 1300 further includes obtaining one or more second images of a second portion of the conveyor conveying the one or more parcels following the first portion, determining whether the defect associated with the at least one parcel is corrected, and causing a second visual indication device associated with the second portion of the conveyor to provide the visual indication of the corrective action for addressing the defect when the defect associated with the at least one parcel is determined to not be corrected, wherein the visual indication is provided on the at least one parcel or the second portion of the conveyor.

In some aspects, method 1300 further includes assigning the corrective action to one of a plurality of workstations, wherein each of the one of the plurality of workstations is associated with one or more portions of the conveyor; and causing the visual indication device to provide the visual indication of the corrective action for addressing the defect to the one of the plurality of workstations. In some aspects, assigning the corrective action to one of the plurality of workstations may be determined based on a profile of a worker assigned to the one of the plurality of workstations.

Note that FIG. 13 is just one example of a method, and other methods including fewer, additional, or alternative operations are possible consistent with this disclosure.

FIG. 14 depicts aspects of an example apparatus 1400 configured for singulation of parcels. In some aspects, apparatus 1400 may be the control unit 260 comprising one or more processors and a non-transitory computer readable memory. The apparatus 1400 may be communicatively coupled to the one or more cameras 202, 204, 206 (e.g., depicted in FIG. 1) and the one or more visual indication devices such as the one or more projectors 212, 214, 216 and/or the one or more light-bars 850, 852.

The apparatus 1400 includes a processing system 1402 coupled to a transceiver 1450 (e.g., a transmitter and/or a receiver). The transceiver 1450 is configured to transmit and receive signals for the apparatus 1400 via an antenna 1452, such as the various signals as described herein. The processing system 1402 may be configured to perform processing functions for the apparatus 1400, including processing signals received and/or to be transmitted by the apparatus 1400.

The processing system 1402 includes one or more processors 1404 and a computer-readable medium/memory 1426. In various aspects, the one or more processors 1404 may be representative of the one or more processors of a computing device. The one or more processors 504 are coupled to a computer-readable medium/memory 1426 via a bus 1448. In some aspects, the computer-readable medium/memory 1426 may be representative of the one or more memories. The computer-readable medium/memory 1426 is a non-transitory computer-readable medium/memory. In certain aspects, the computer-readable medium/memory 1426 is configured to store instructions (e.g., computer-executable code), that when executed by the one or more processors 1404, cause the one or more processors 1404 to perform method 1300 described with respect to FIG. 13, or any aspect related to it, including any operations described in relation to FIG. 13. Note that reference to a processor performing a function of apparatus 1400 may include one or more processors performing that function of apparatus 1400, such as in a distributed fashion.

In the depicted example, computer-readable medium/memory 526 stores code (e.g., executable instructions), including code for obtaining 1428, code for detecting 1430, code for determining 1432, code for generating 1434, code for causing 1436, and code for assigning 1438. Processing of the code 1428-1438 may enable and cause the apparatus 1400 to perform the method 1300 described with respect to FIG. 13, or any aspect related to it.

The one or more processors 1404 include circuitry configured to implement (e.g., execute) the code stored in the computer-readable medium/memory 1426, including circuitry for obtaining 1406, circuitry for detecting 1408, circuitry for determining 1410, circuitry for generating 1412, circuitry for causing 1414, and circuitry for assigning 1416. Processing with circuitry 1406-1416 may enable and cause the apparatus 1400 to perform the method 1300 described with respect to FIG. 13, or any aspect related to it.

More generally, means for communicating, transmitting, sending or outputting for transmission may include the one or more transceivers 1450 and/or antenna 1452 of the apparatus 1400 in FIG. 14, and/or one or more processors 1404 of the apparatus 1400 in FIG. 14. Means for communicating, receiving or obtaining may include the one or more transceivers 1450 and/or antenna 1452 of the apparatus 1400 in FIG. 14, and/or one or more processors 1404 of the apparatus 1400 in FIG. 14.

### EXAMPLE CLAUSES

Implementation examples are described in the following numbered clauses:

Clause 1: A method for singulating parcels comprising obtaining one or more images of a first portion of a conveyor conveying one or more parcels; detecting at least one parcel being conveyed along the conveyor based on the one or more images; determining a defect associated with the at least one parcel; generating a corrective action for addressing the defect associated with the at least one parcel; and causing a visual indication device to provide a visual indication of the corrective action for addressing the defect.

Clause 2: The method of Clause 1, wherein obtaining the one or more images are obtained from one or more cameras configured to view the first portion of the conveyor and capture the one or more images of the first portion of the conveyor conveying the one or more parcels.

Clause 3: The method of any one of Clauses 1-2, wherein the visual indication device comprises one or more projectors, wherein the one or more projectors are configured to project a light-based indication onto the at least one parcel or the first portion of the conveyor and the light-based indication is the visual indication of the corrective action.

Clause 4: The method of any one of Clauses 1-3, wherein the visual indication comprises a respective color corresponding to the corrective action of a plurality of corrective actions.

Clause 5: The method of any one of Clauses 1-4, wherein the visual indication comprises a respective icon corresponding to the corrective action of a plurality of corrective actions.

Clause 6: The method of any one of Clauses 1-5, wherein the visual indication device comprises one or more light bars, wherein: the one or more light bars are positioned along the first portion first of the conveyor, and the one or more light bars are configured to project a light-based indication is the visual indication of the corrective action.

Clause 7: The method of any one of Clauses 1-6, wherein determining the defect associated with the at least one parcel comprises identifying a location of a SLAM label on the at least one parcel, and determining that the SLAM label is in an orientation other than a predefined orientation.

Clause 8: The method of any one of Clauses 1-7, wherein the defect comprises at least one of: an undesired orientation of the at least one parcel; the at least one parcel includes a fold; two or more parcels including the at least one parcel are positioned side-by-side in a lateral direction with respect to the conveyor; or two or more parcels including the at least one parcel are overlap each other.

Clause 9: The method of any one of Clauses 1-8, wherein the defect comprises a gap located before or after the at least one parcel and the processing system is configured to cause the visual indication device to provide the visual indication corresponding to an action to add a parcel in the gap by illuminating the gap with the visual indication.

Clause 10: The method of any one of Clauses 1-9, further comprises obtaining one or more second images of a second portion of the conveyor conveying the one or more parcels following the first portion; determining whether the defect associated with the at least one parcel is corrected; and causing a second visual indication device associated with the second portion of the conveyor to provide the visual indication of the corrective action for addressing the defect when the defect associated with the at least one parcel is determined to not be corrected, wherein the visual indication is provided on the at least one parcel or the second portion of the conveyor.

Clause 11: The method of any one of Clauses 1-10 further comprises assigning the corrective action to one of a plurality of workstations, wherein each of the one of the plurality of workstations is associated with one or more portions of the conveyor; and causing the visual indication device to provide the visual indication of the corrective action for addressing the defect to the one of the plurality of workstations.

Clause 12: The method of Clause 11, wherein to assign the corrective action to one of the plurality of workstations is determined based on a profile of a worker assigned to the one of the plurality of workstations.

Clause 13: One or more apparatuses, comprising: one or more memories comprising executable instructions; and one or more processors configured to execute the executable instructions and cause the one or more apparatuses to perform a method in accordance with any one of Clauses 1-12.

Clause 14: One or more apparatuses configured for feature detection and extraction, comprising: one or more memories; and one or more processors, coupled to the one or more memories, configured to cause the one or more apparatuses to perform a method in accordance with any one of Clauses 1-12.

Clause 15: One or more apparatuses configured for feature detection and extraction, comprising: one or more memories; and one or more processors, coupled to the one or more memories, configured to perform a method in accordance with any one of Clauses 1-12.

Clause 16: One or more apparatuses, comprising means for performing a method in accordance with any one of Clauses 1-12.

Clause 17: One or more non-transitory computer-readable media comprising executable instructions that, when executed by one or more processors of one or more apparatuses, cause the one or more apparatuses to perform a method in accordance with any one of Clauses 1-12.

Clause 18: One or more computer program products embodied on one or more computer-readable storage media comprising code for performing a method in accordance with any one of Clauses 1-12.

Clause 19: One or more apparatuses configured for feature detection and extraction, comprising: a processing system that includes one or more processors and one or more memories coupled with the one or more processors, the processing system configured to cause the one or more apparatuses to perform a method in accordance with any one of Clauses 1-12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A apparatus for singulating parcels comprising a processing system that includes one or more processors and one or more memories coupled with the one or more processors, the processing system configured to:
obtain one or more images of a first portion of a conveyor conveying one or more parcels;
detect at least one parcel being conveyed along the conveyor based on the one or more images;
determine a defect associated with the at least one parcel;
generate a corrective action for addressing the defect associated with the at least one parcel; and
cause a visual indication device to provide a visual indication of the corrective action for addressing the defect.

2. The apparatus of claim 1, further comprising one or more cameras communicatively coupled to the processing system, wherein the one or more cameras are configured to view the first portion of the conveyor and capture the one or more images of the first portion of the conveyor conveying the one or more parcels.

3. The apparatus of claim 1, wherein the visual indication device comprises one or more projectors communicatively coupled to the processing system, wherein the one or more projectors are configured to project a light-based indication onto the at least one parcel or the first portion of the conveyor and the light-based indication is the visual indication of the corrective action.

4. The apparatus of claim 1, wherein the visual indication comprises a respective color corresponding to the corrective action of a plurality of corrective actions.

5. The apparatus of claim 1, wherein the visual indication comprises a respective icon corresponding to the corrective action of a plurality of corrective actions.

6. The apparatus of claim 1, wherein the visual indication device comprises one or more light bars communicatively coupled to the processing system, wherein:
the one or more light bars are positioned along the first portion first of the conveyor, and
the one or more light bars are configured to project a light-based indication is the visual indication of the corrective action.

7. The apparatus of claim 1, wherein to determine the defect associated with the at least one parcel the processing system is configured to:
identify a location of a SLAM label on the at least on parcel, and
determine that the SLAM label is in an orientation other than a predefined orientation.

8. The apparatus of claim 1, wherein the defect comprises at least one of:
an undesired orientation of the at least one parcel;
the at least one parcel includes a fold;
two or more parcels including the at least one parcel are positioned side-by-side in a lateral direction with respect to the conveyor; or
two or more parcels including the at least one parcel are overlap each other.

9. The apparatus of claim 1, wherein the defect comprises a gap located before or after the at least one parcel and the processing system is configured to cause the visual indication device to provide the visual indication corresponding to an action to add a parcel in the gap by illuminating the gap with the visual indication.

10. The apparatus of claim 1, wherein the processing system is configured to:
obtain one or more second images of a second portion of the conveyor conveying the one or more parcels following the first portion;
determine whether the defect associated with the at least one parcel is corrected; and
cause a second visual indication device associated with the second portion of the conveyor to provide the visual indication of the corrective action for addressing the defect when the defect associated with the at least one parcel is determined to not be corrected, wherein the visual indication is provided on the at least one parcel or the second portion of the conveyor.

11. The apparatus of claim 1, wherein the processing system is configured to:
assign the corrective action to one of a plurality of workstations, wherein each of the one of the plurality of workstations is associated with one or more portions of the conveyor; and
cause the visual indication device to provide the visual indication of the corrective action for addressing the defect to the one of the plurality of workstations.

12. The apparatus of claim 11, wherein to assign the corrective action to one of the plurality of workstations is determined based on a profile of a worker assigned to the one of the plurality of workstations.

13. A method for singulating parcels comprising:
obtaining one or more images of a first portion of a conveyor conveying one or more parcels;
detecting at least one parcel being conveyed along the conveyor based on the one or more images;
determining a defect associated with the at least one parcel;
generating a corrective action for addressing the defect associated with the at least one parcel; and
causing a visual indication device to provide a visual indication of the corrective action for addressing the defect.

14. The method of claim 13, wherein obtaining the one or more images are obtained from one or more cameras configured to view the first portion of the conveyor and capture the one or more images of the first portion of the conveyor conveying the one or more parcels.

15. The method of claim 13, wherein the visual indication device comprises one or more projectors, wherein the one or more projectors are configured to project a light-based indication onto the at least one parcel or the first portion of the conveyor and the light-based indication is the visual indication of the corrective action.

16. The method of claim 13, wherein the visual indication comprises a respective color corresponding to the corrective action of a plurality of corrective actions.

17. The method of claim 13, wherein the visual indication comprises a respective icon corresponding to the corrective action of a plurality of corrective actions.

18. The method of claim 13, wherein the visual indication device comprises one or more light bars, wherein:
the one or more light bars are positioned along the first portion first of the conveyor, and
the one or more light bars are configured to project a light-based indication is the visual indication of the corrective action.

19. A system for singulating parcels comprising:
a processing system that includes one or more processors and one or more memories coupled with the one or more processors;
one or more cameras communicatively coupled to the processing system, wherein the one or more cameras are configured to view a first portion of a conveyor and capture one or more images of the first portion of the conveyor conveying one or more parcels;
one or more projectors communicatively coupled to the processing system, wherein the processing system configured to:
obtain, from the one or more cameras, the one or more images of the first portion of the conveyor conveying the one or more parcels;
detect at least one parcel being conveyed along the conveyor based on the one or more images;
determine a defect associated with the at least one parcel;
generate a corrective action for addressing the defect associated with the at least one parcel; and
cause the one or more projectors to project a light-based indication onto the at least one parcel or the first portion of the conveyor, wherein the light-based indication is a visual indication of the corrective action for addressing the defect.

20. The system of claim 19, wherein the processing system is configured to:
assign the corrective action to one of a plurality of workstations, wherein each of the one of the plurality of workstations is associated with one or more portions of the conveyor; and
cause the one or more projectors to project the light-based indication of the corrective action for addressing the defect to the one of the plurality of workstations.
